(19) United States
(12) Patent Application Publication
(10) Pub. No.: US 2003/0044222 A1
(43) Pub. Date: Mar. 6, 2003

(54) Conformable binders

(75) Inventors: Robert Melvin Dahlke, Meridian, MS (US); Lawrence Kevin Carney, Easthampton, MA (US)

Correspondence Address: OPPENHEIMER WOLFF & DONNELLY LLP, 38th Floor, 2029 Century Park East, Los Angeles, CA, 90067-3024, US

(73) Assignee: Avery Dennison Corporation

(21) Appl. No.: 09/948,404

(22) Filed: Sep. 6, 2001

(51) Int. Cl. B42F 3/02

(52) U.S. Cl. 402/73

(57) ABSTRACT

A set of binders includes round ring binders and binders with flattened rings, having the same exterior appearance, but with the flattened ring binders, accommodating wider sheets, such as index sheets. Individual flattened ring binders include reliable over-center ring operating action with elongated plates to which the rings are secured, and an overlying elongated spring cover to apply inward pressure on the plates. Using flattened rings, the covers of the binders may be reduced in extent.

### BACKGROUND OF THE INVENTION

1. Field of the Invention

This invention relates to ring binders of the type which usually have three rings.

2. General Background and State of the Art

It has previously been proposed to use ring binders with various shapes of rings, as shown in the following patents: U.S. Pat. No. 6,027,275; U.S. Pat. No. 5,332,327; U.S. Pat. No. 5,015,115; U.S. Pat. No. 4,820,071; U.S. Pat. No. 4,623,276; U.S. Pat. No. 3,333,592; U.S. Pat. No. 3,104,667; U.S. Pat. No. 3,066,680; U.S. Pat. No. 2,323,285; U.S. Pat. No. 1,094,019; U.S. Design Pat. No. 293,335; International Application No. PCT/US00/10350; Great Britain Patent No. 2,214,466 A; and German Patent No. 250,296

In considering the foregoing special binders, it is noted that they do not include flattened ring configurations along with standard inexpensive conventional ring binder opening mechanisms of the over center type with two long metal plates to which the rings are secured, and an overlying sheet metal spring for engaging the outer edges of the plates.

It is also noted that when index sheets are included in a ring notebook, the index tabs may extend out beyond the edges of the covers; or alternatively, the covers may be made somewhat longer than is required for encompassing standard sheets of paper, so that the covers extend over and protect the outwardly extending tabs.

### INVENTION SUMMARY

In accordance with one aspect of the invention, it has been determined that a set of binders assemblies may include binders of two different configurations, one with conventional round rings for holding only standard sized sheets, and another with somewhat flattened rings and enclosing both regular size sheets of paper, and also index sheets with outwardly extending tabs. With these constructions, the two types of binders may have identical exterior configurations with covers of the same size.

Preferably the two types of binders will include conventional reliable and inexpensive ring operating mechanisms as elaborated hereinabove.

In accordance with another aspect of the invention a binder may be provided with a conventional ring operating mechanism and somewhat flattened rings, to reduce the outward extent of the paper sheets and/or tabbed dividers mounted in the binder, while providing the reliable action of the double plate over-center ring actuation mechanism. Substantial cost savings may also be realized as the length of the covers may be reduced substantially when the flattened rings are employed.

Other objects, features and advantages will become apparent from a consideration of the following detailed description, and the accompanying drawings.

### BRIEF DESCRIPTION OF THE DRAWINGS

FIG. 1 shows a set of binders with the same size covers and spine, but with different ring configurations;

FIG. 2 shows two different binders having the same size covers and spine, but with one binder having round retainer rings and the other having flattened rings and outwardly extending sheets, such as tabbed divider sheets;

FIGS. 3 and 4 show the different binders of FIG. 2 with the covers open;

FIGS. 5, 6 and 7 show the flattened ring assemblies in perspective, in cross-section closed and in cross-section open, respectively;

FIG. 8 is an end view of a binder with flattened rings; and

FIG. 9 is an end view of a binder with conventional round rings.

### DETAILED DESCRIPTION OF THE PREFERRED EMBODIMENTS

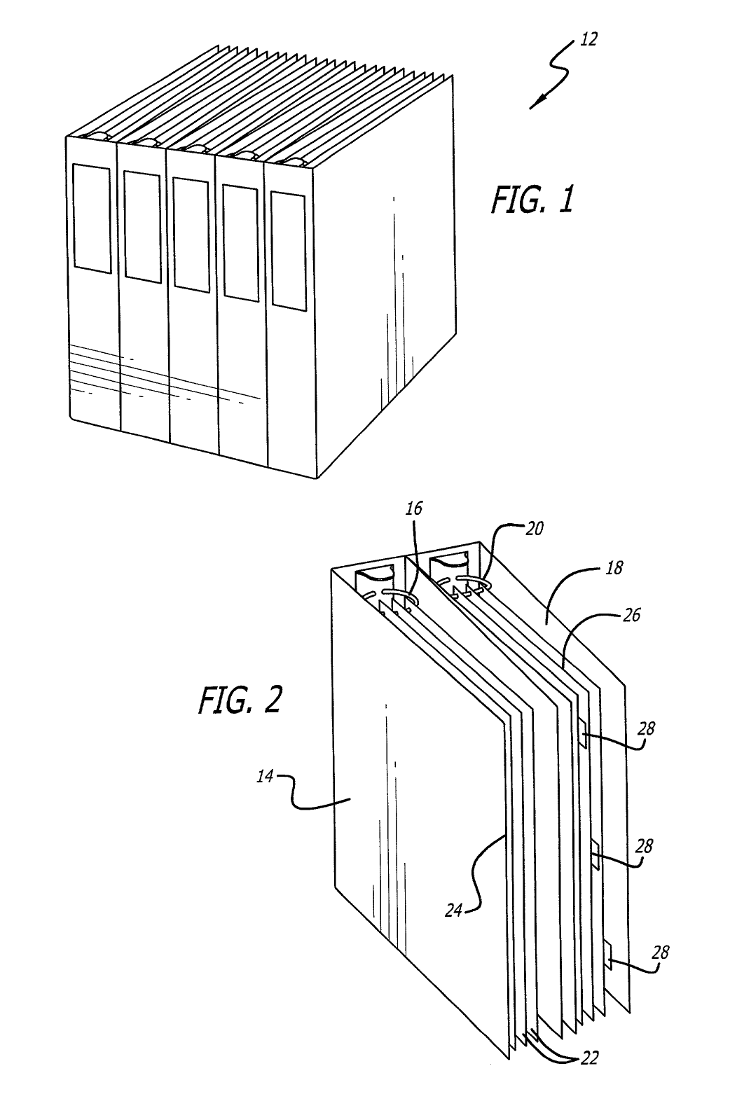

Referring more particularly to the drawings, FIG. 1 shows a set of binders 12, some of which may have conventional circular rings and ring mounting mechanisms and others binders in the set of binders may have modified or somewhat flattened rings as will be described in greater detail herein below.

Referring now to FIG. 2, this figure shows a first binder 14 which has conventional circular rings 16; and a second binder 18 in which the securing rings 20 are somewhat flattened in their outward extent. Because the binder 14 has round rings 16, the pages 22 of binder 14 extend outwardly toward the outer edges 24 of binder 14 to a greater extent than the pages 26 of binder 18. However, because the binder 18 has index divider tabs 28 which extend outward by a substantial distance such as about 1/2 inch, the covers of the binder 18, which may be identical to the covers of binder 14, enclose the index divider tabs 28 so that they do not extend beyond the outer edges of the covers of the binder 18.

Accordingly, in the set of binders 12, shown in FIG. 1, both types of binders, some with somewhat flattened rings and some with round rings may be included in the set. They will then look identical from the outside, but with some of the binders having somewhat flattened rings and having outwardly extending index dividers so that the index tabs are properly protected by the covers.

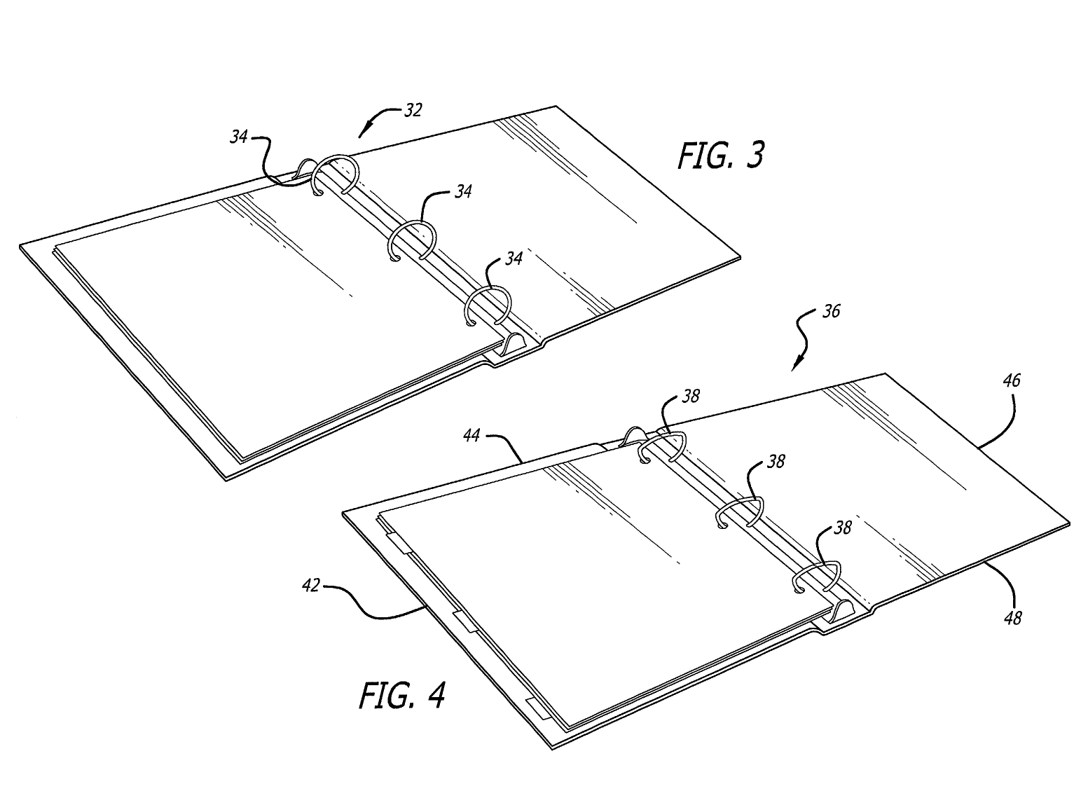

FIGS. 3 and 4 show a first binder 32 with round retaining rings 34 and a second binder 36 with somewhat flattened retaining rings 38. To give an indication of the amount of saving which may be achieved using the somewhat flattened rings 38, as shown in FIG. 4, with a fairly large size ring binder where the total width of the binder is approximately 3 inches, the pages or sheets of paper held in the binder are reduced in their outward extent by approximately one-half of one inch. Accordingly, if the pages are to extend out the same distance relative to the covers as with conventional circular ring binders, the covers may be one-half inch shorter. Alternatively, if the same size covers are employed, the additional outward extent of index sheets may be accommodated without the index tabs extending beyond the covers of the binders.

With the covers each being 1/2″ reduced in size, the total distance from the outer edge 42 of one of the covers 44, to the outer edge 46 of the other cover 48 as shown in FIG. 4 may be reduced by 1″. With reduction in the size of the binder, there is an approximate saving of 2.7 cents per case of binders, where each case of 3 inch binders includes six binders. While this amount may seem fairly small, for manufacturers making large numbers of binders the savings can involve several millions of dollars per year.

To give specifics of the dimensions on one well known size of binders, the 3″ binders, the total distance between edges such as shown at 42 and 46 of FIG. 4 of the drawings, would normally be 26.063 inches, and this would be reduced by approximately one inch to about 25 inches, using the somewhat flattened rings. For 2 inch ring binders a normal distance from edge to edge as discussed above would be about 24.8 inches, and using the somewhat flattened rings this total distance would be reduced by about one-half inch, or involve a shortening of the covers by one quarter inch each. Incidentally, the covers of standard circular ring binders normally extend outward about one fourth to one-half inch beyond the sheets of paper.

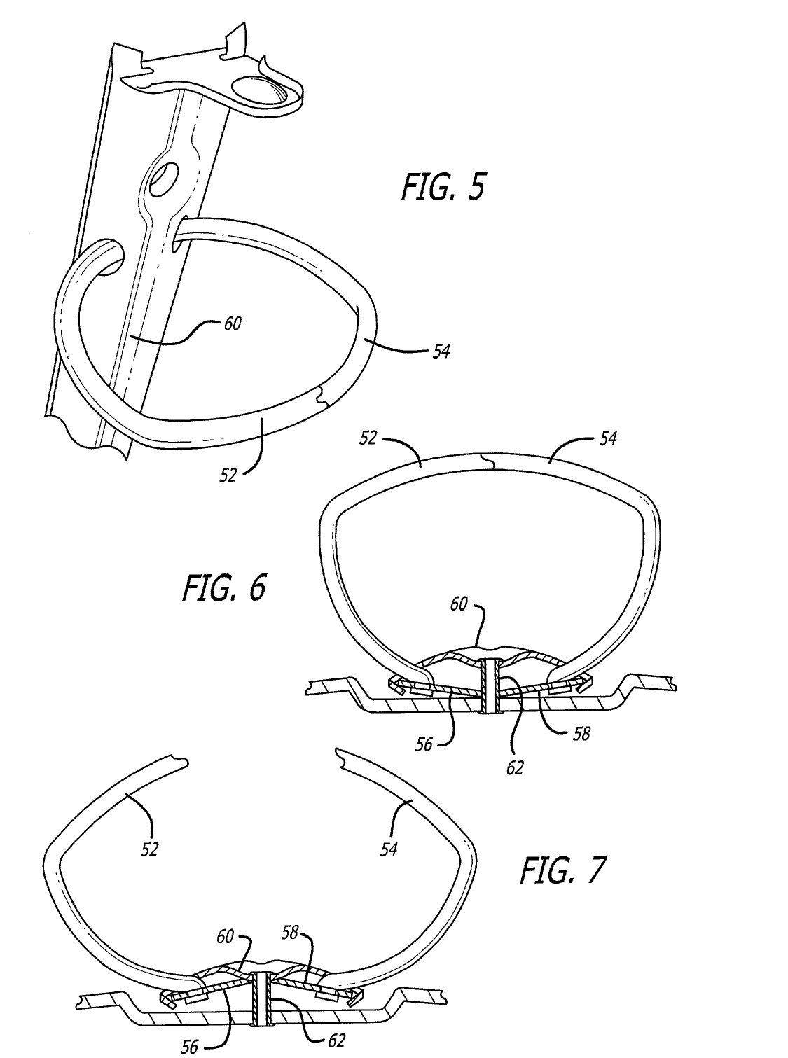

FIGS. 5, 6 and 7 show the detailed construction of the somewhat flattened ring assembly configuration, using reliable conventional over center action. More specifically, referring to FIG. 6 of the drawings, the ring portions 52 and 54, are secured to the elongated plates 56 and 58 respectively. Inward pressure on the outer edges of the plates 56 and 58 is provided by the elongated spring cover member 60. With the over center action provided by plates 56 and 58, and spring member 60, the rings have two stable positions, the closed position as shown in FIG. 6, with the inner edges of the plates 56, 58 extending downwardly, and the open configuration of the rings 52, 54, as shown in FIG. 7, with the inner edges of the plates 56 and 58 extending upwardly to engage the spring member 60 adjacent the rivet 62.

Incidentally, for completeness, the perspective view of FIG. 5 is provided, with the rings shown in their closed position.

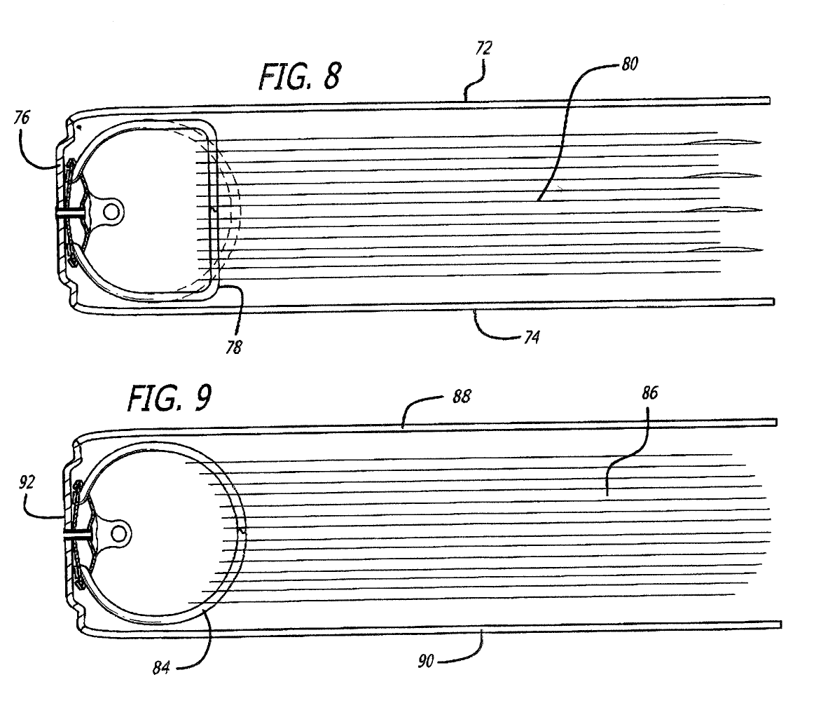

Referring now to FIGS. 8 and 9 of the drawings, a contrast between a binder with the somewhat flattened rings with a binder having the fully round rings is presented. In FIG. 8 of the drawings, the two covers 72 and 74 and the spine 76 are shown along with the somewhat flattened rings 78. In this figure the outward extent of the sheets 80 contained in the binder of FIG. 8 are substantially even, as seen at the right hand edge of FIG. 8.

On the other hand, referring to FIG. 9, which has the round rings 84, the sheets 86 have edges shown at the far right in FIG. 9 which are curved, to match the curvature of the round rings 84. Incidentally, for completeness, the binder of FIG. 9 also includes the covers 88 and 90 and the spine 92.

For completeness, if is noted that, as compared with standard 8½×11 inch sheets, the index tabs normally protrude about ½ inch, so that the overall dimensions of index sheets and approximately 9×11 inches. It is further noted that the binders disclosed in this specification include three stiff or semi-flexible sheet material parts, the spine and the two covers, with the covers and the spine being fairly stiff or only semi-flexible, except at the hinge links where the spine is hinged to the covers.

In the foregoing detailed description certain specific embodiments illustrating the principles of the invention have been shown. It is to be understood, however, that various minor changes and modifications can be made without departing from the spirit and scope of the invention. In this regard, the invention may be employed with various size rings and binders and with binders formed of different types of materials. Thus, by way of example and not of limitations, in some cases the binders may be formed of pressed material covered with very thin sheets of plastic, and other cases fairly thick sheets of plastic such as polypropylene may be employed to form fairly stiff or semi-flexible binders. Accordingly, the present invention is not limited to the exact embodiments and dimensions as set forth in the detailed description.

What is claimed is:

1. A set of ring binders with substantially identical exterior appearance comprising:
a first binder having a spine, a front cover and a rear cover of predetermined dimensions;
said first binder having a reclosable ring assembly with substantially circular rings mounted on the spine thereof;
standard size 8½×11 inch or A-4 size sheets of paper mounted in said first binder, said sheets of paper being covered by said covers when said binder is closed;
a second binder having a spine, a front cover and a rear cover of substantially the same predetermined dimensions as said first binder;
said second binder have a reclosable ring assembly mounted on said spine, with rings which are somewhat flattened or slightly oval in the portion of the rings away from the spine; and
paper of standard size 8½×11 inch or A-4 sheets of paper mounted in said second binder along with divider sheets with tabs which extend beyond said sheets of paper to permit legible printing on the tabs of said dividers;
said covers of said second binder covering both said sheets of paper and said divider tabs when said second binder is closed; and
said two binders having substantially the same size and exterior appearance, with said divider tabs of said second binder extending outwardly from the associated rings approximately as far as the sheets of paper in said first binder.

2. A set of ring binders as defined in claim 1 wherein the releasable ring assembly of each type of binder has an over-center assembly with an overlying sheet metal spring for engaging the outer edges of two elongated metal plates forming part of said assembly, and with the rings secured to said plates.

3. A set of ring binders as defined in claim 1 wherein the rings of said second binder in the closed configuration have a maximum distance across the rings of approximately 2½ to 3 inches, and wherein the flattened portion of said rings deviates from circular by approximately ½inch.

4. A set of binders as defined in claim 1 wherein said front and rear covers and said spine of each of said binders are formed of relatively stiff or semi-flexible sheet material, with the sheet material of said spine being hingedly coupled to said covers, and with said ring assembly being firmly secured to the sheet material of said spine.

5. A set of binders as defined in claim 1 wherein the spine of each of said binders is a single flat stiff or semi-flexible extending from the hinge line with said front cover to the hinge line with said second cover.

6. A ring binder comprising:
a front cover, a rear cover and a spine, with said covers being hingedly secured to said spine along hinge lines;
releasable rings mounted on said spine for holding sheets of paper, said rings being somewhat flattened or somewhat oval in the portion of the rings away from said spine;
said rings being mounted on a bistable over-center assembly with an overlying sheet metal spring for engaging the outer edges of two elongated metal plates forming part of said assembly, and with the rings secured to said plates; and
said covers extending barely beyond the edges of standard 8½ by 11 inch of a A-4 size sheets having normal punched holes therein; said covers being substantially shorter than the covers of standard binders with circular rings having comparable capacity.

7. A ring binder as defined in claim 6 wherein said rings in the closed configuration have a maximum distance across the rings of approximately 2½ to 3 inches and wherein the extent of each of said covers is reduced by approximately ½ inch as compared with the extent of covers of binders having substantially circular rings.

8. A binder as defined in claim 7 wherein the distance between the outer edges of the two covers of said binder when the binder is fully opened on a flat surface is approximately 25 inches.

9. A binder as defined in claim 6 wherein said sheets include protruding index tabs, and wherein said covers extend outward from said spine for substantially the same distance as said index tabs.

10. A set of binders as defined in claim 6 wherein the spine of each of said binders is a single flat stiff or semi-flexible extending from the hinge line with said front cover to the hinge line with said second cover.

11. A set of ring binders with substantially identical exterior appearance comprising:
a first binder having a spine, a front cover and a rear cover of predetermined dimensions, said covers being hinged to said spine;
said first binder having a reclosable ring assembly with substantially circular rings mounted on the spine thereof;
a second binder having a spine, a front cover and a rear cover of the same predetermined dimensions as said first binder;
said second binder have a reclosable ring assembly mounted on said spine, with rings which are somewhat flattened or slightly oval in the portion of the rings away from the spine; and
said two binders having substantially the same size and exterior appearance, with said second binder accommodating wider sheets of paper than said first binder.

12. A set of ring binders as defined in claim 11 wherein the releasable ring assembly of each type of binder has an over-center assembly with an overlying sheet metal spring for engaging the outer edges of two elongated metal plates forming part of said assembly, and with the rings secured to said plates.

13. A set of ring binders as defined in claim 11 wherein the rings of said second binder in the closed configuration have a maximum distance across the rings of approximately 2½ to 3 inches, and wherein the flattened portion of said rings deviates from circular by approximately 1/2 inch.

14. A set of binders as defined in claim 11 wherein said front and rear covers and said spine are formed of relatively stiff or semi-flexible sheet material, with the sheet material of said spine being hingedly coupled to said covers, and with said ring assembly being firmly secured to the sheet material of said spine.

15. A set of binders as defined in claim 10 wherein the spine of each of said binders is a single flat stiff or semi-flexible extending from the hinge line with said front cover to the hinge line with said second cover.

16. A ring binder comprising:
a front cover, a rear cover and a spine;
releasable rings mounted on said spine for holding sheets of paper, said rings being somewhat flattened or somewhat oval in the portion of the rings away from said spine;
said rings being mounted on a bistable over-center assembly with an overlying sheet metal spring for engaging the outer edges of two elongated metal plates forming part of said assembly, and with the rings secured to said plates;
said covers extending barely beyond the edges of standard 8½ by 11 inch of a A-4 size sheets having normal punched holes therein; said covers being substantially shorter than the covers of standard binders with circular rings having comparable capacity; and
said front and rear covers and said spine being formed of relatively stiff or semi-flexible sheet material, with the sheet material of said spine being hingedly coupled to said covers, and with said ring assembly being firmly secured to the sheet material of said spine.

17. A ring binder as defined in claim 16 wherein said rings in the closed configuration have a maximum distance across the rings of approximately 2½ to 3 inches and wherein the extent of each of said covers is reduced by approximately ½ inch as compared with the extent of covers of binders having substantially circular rings.

18. A binder as defined in claim 17 wherein the distance between the outer edges of the two covers of said binder when the binder is fully opened on a flat surface is approximately 25 inches.

19. A binder as defined in claim 16 wherein said sheets include protruding index tabs, and wherein said covers extend outward from said spine for substantially the same distance as said index tabs.

20. A ring binder as defined in claim 16 wherein said rings in the closed configuration have a maximum distance across the rings of approximately 2 inches and wherein the extent of each of said covers is reduced by approximately ¼ inch as compared with the extent of covers of binders having substantially circular rings.
